(19) United States
(12) Patent Application Publication
(10) Pub. No.: US 2014/0149168 A1
(43) Pub. Date: May 29, 2014

(54) OUTBOUND DIALING PACE

(71) Applicants: Georgiy Shashkov, Berkeley, CA (US); Stanislav Zgardovski, Concord, CA (US); Alex Kolomoyskyy, Moraga, CA (US)

(72) Inventors: Georgiy Shashkov, Berkeley, CA (US); Stanislav Zgardovski, Concord, CA (US); Alex Kolomoyskyy, Moraga, CA (US)

(21) Appl. No.: 13/685,666

(22) Filed: Nov. 26, 2012

(51) Int. Cl. G06Q 10/06

(52) U.S. Cl. CPC G06Q 10/06
USPC 705/7.22

(57) ABSTRACT

A method establishes a formula for average value factor for an outbound campaign having a known number of agents, a known gain for an established call, and a known loss for an abandoned call, wherein the average value factor is a function of dialing pace and the known values. The method assumes a first value for dialing pace and calculates by a computing device having a processor, following the established formula, a first average value factor. Assuming a second value for dialing pace, the method repeats calculation of average value factor by the computing device, and notes direction of change in the calculated average value factor. The method then determines a maximum for the average value factor by successive choices for dialing pace chosen to increase the average value factor, and uses the dialing pace that produces in calculation the maximum average value factor to drive the outbound campaign.

### FIELD

The present invention is in the technical area of managing outbound dialing campaigns, and pertains more particularly to determining proper pacing of calls.

### BACKGROUND

Administrators of contact centers running outbound campaigns often are not clear on how to best optimize resource utilization. Because Agent Busy Factor and Overdial Rate are essentially independent, but may be dependent on the number of available agents, setting parameters to optimize performance may be difficult and imprecise.

### SUMMARY

A method is provided comprising establishing a formula for average value factor for an outbound campaign having a known number of dedicated agents, a known financial gain for an established call, and a known financial loss for an abandoned call, wherein the average value factor is a function of dialing pace and the known values. A first value for dialing pace is assumed, and a first average value factor is calculated by a computing device having a processor, following the established formula. Assuming a second value for dialing pace, the method repeats calculation of average value factor by the computing device, and notes direction of change in the calculated average value factor. The method determines a maximum for the average value factor by successive choices for dialing pace chosen to increase the average value factor. The maximum average value factor determined is used to drive the outbound campaign.

In some implementations the method may further comprise, upon the number of dedicated agents changing, repeating the process for determining the maximum average value factor, and establishing a new dialing pace that results in the maximum average value factor for the new number of dedicated agents.

Also in some implementations the method may further comprise, upon the known financial gain for an established call changing, repeating the process for determining the maximum average value factor, and establishing a new dialing pace that results in the maximum average value factor for the new value of financial gain.

In still other implementations the method may further comprise, upon the financial loss for an abandoned call changing, repeating the process for determining the maximum average value factor, and establishing a new dialing pace that results in the maximum average value factor for the new value for financial loss.

In still other implementations the method may further comprise determining an agent busy factor as a function of dialing pace and number of agents as a part of the calculations using the established formula.

In some implementations the method may further comprise determining an overdial rate as a function of dialing pace and number of agents as a part of the calculations using the established formula, and in other implementations may further comprise determining, after calculating a first average value factor, whether increasing or decreasing the value for dialing pace causes the average value factor to increase or decrease, and adjusting the second and subsequent choices for dialing pace to cause the average value factor to increase until the maximum value is reached.

In another aspect of the invention an apparatus is provided, comprising a processor and a memory, the memory storing instructions that when executed by the processor, cause the processor to assume a first value for dialing pace and calculate by a computing device having a processor, following an established formula wherein a number of dedicated agents is known, a financial gain for an established call is known, and a financial loss for an abandoned call is known, and the average value factor is a function of dialing pace and the known values, a first average value factor, to assume a second value for dialing pace, repeat calculation of average value factor by the computing device following the formula, and note direction of change in the calculated average value factor, and to determine a maximum for the average value factor by successive choices for dialing pace chosen to increase the average value factor. The dialing pace that produces in calculation the maximum average value factor is used to drive the outbound campaign.

In some implementations, upon the number of dedicated agents changing, the process is repeated for determining the maximum average value factor, and a new dialing pace is established that results in the maximum average value factor for the new number of dedicated agents. Also in some implementations, upon the known financial gain for an established call changing, repeating the process for determining the maximum average value factor, and establishing a new dialing pace that results in the maximum average value factor for the new value of financial gain.

In some implementations, upon the financial loss for an abandoned call changing, the process is repeated for determining the maximum average value factor, and a new dialing pace is established that results in the maximum average value factor for the new value for financial loss.

In still other implementations the method further comprises determining an agent busy factor as a function of dialing pace and number of agents as a part of the calculations using the established formula. In other implementations the method further comprises determining an overdial rate as a function of dialing pace and number of agents as a part of the calculations using the established formula. In yet other implementations the method further comprises determining, after calculating a first average value factor, whether increasing or decreasing the value for dialing pace causes the average value factor to increase or decrease, and adjusting the second and subsequent choices for dialing pace to cause the average value factor to increase until the maximum value is reached.

### BRIEF DESCRIPTION OF THE DRAWINGS

FIG. 1 is an architectural diagram of a system in one implementation.

FIG. 2 is a table illustrating calculated values and acts in an iterative procedure for determining the dialing pace in another implementation.

FIG. 3 is an exemplary curve relating value AR to dialing pace DP.

FIG. 4 is a flow diagram illustrating acts in an iterative procedure for determining dialing pace to maximize value to a contact center.

FIG. 5 is a table illustrating acts in an iterative procedure for determining the dialing pace in another implementation.

### DETAILED DESCRIPTION

Because cost of agents is often an expensive resource in outbound dialing campaigns, managing agents' time is seen to be desirable. Efficient agent utilization, known in the art as Agent Busy Factor however, may lead to an increase in abandoned calls, and because each abandoned call may have a negative financial effect, careful management of dialing rate is important. Embodiments of the present invention are directed to a method and system for determining a dialing rate for maximizing value generation in outbound campaigns.

Administrators of contact centers running outbound campaigns often are not clear on how to best optimize resource utilization. An expensive asset of the contact center may be agent cost, so it may be beneficial to maximize the time agents spend productively, (e.g. handling calls). However there may be trade-offs to maximizing agent's busy time. Such tradeoffs may come in the form of abandoned calls, such as calls which were over-dialed, requiring callers to wait in the queue for an agent to become available. Such calls may be dropped from the queue as callers hang up, tired of waiting for an agent.

An increase in agent utilization (a higher Agent Busy Factor) may lead to an increase in percentage of abandoned calls (Overdial Rate). While each established call may mean some monetary benefit to the contact center, each abandoned call may incur some loss in the form of the telecom costs, missed sales opportunities, frustrated customers, and the like.

In conditions with no explicit legal limitations where it is legally acceptable for some calls to be dialed and then get dropped, not being connected to an agent, contact center managers may want outbound campaigns to achieve high Agent Busy Factor (ABF) with a moderate Overdial Rate (OR) value, which may not be a well-defined goal. It is usually not at all clear to the administrator of an outbound campaign how to select campaign optimization parameters. Understanding how optimization parameters might be best set for outbound campaigns typically comes with experience, often via trial and error. The task of selecting proper optimization parameters may get even more complicated because Agent Busy Factor and Overdial Rate are independent, but may be dependent on the number of available agents, which may vary significantly during an outbound campaign session. A contact center may operate a plurality of outbound campaigns simultaneously, so in practical terms, a significant number of outbound campaigns running in a contact center (if not all of them) may be operating in a way that does not maximize value generation for the contact center.

Methods are provided by implementations described herein to periodically determine and set a Dialing Pace in an outbound campaign to maximize value generation for the contact center, and to adjust the Dialing Pace as conditions, such as the number of available agents, varies.

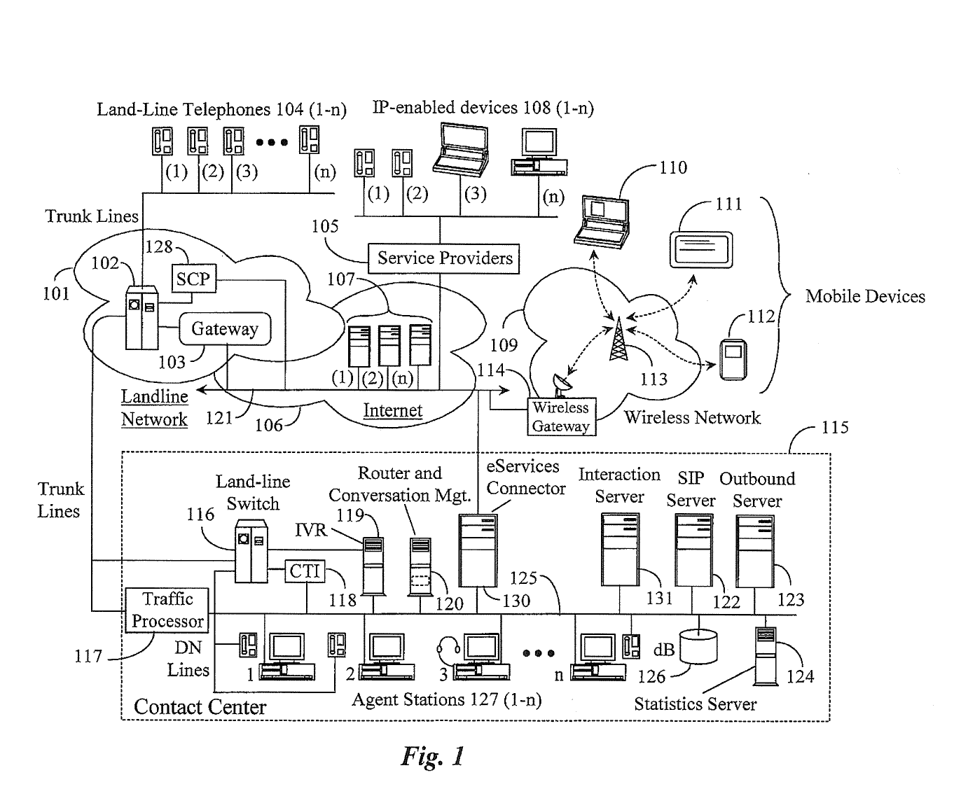

FIG. 1 is an exemplary diagram of a contact center 115 and a plurality of networks with interconnections whereby customers and remote agents may interact with the contact center. Contact center 115 may be hosted by one enterprise or by more than one enterprise, and one enterprise may employ more than one contact center. Customers and agents may interact with the contact center 115 through communication appliances such as, for example, land-line telephones 104 (1-n), IP-enabled devices 108 (1-n), or through mobile appliances 110, 111 or 112. In some circumstances, the interaction may be limited to voice, but in other circumstances, the interaction my include text interaction, such as, for example, email, messaging services, chat, and the like.

Persons interacting through land-line telephones 104 may connect firstly over trunk lines as shown to a network switch 102. Switch 102 may interact with hardware and software of a Service Control Point (SCP) 128, which may execute intelligent operations to determine to connect an incoming call to different ones of possible contact centers or to route an incoming call directly to an agent in a contact center or to an agent operating as a remote agent outside a contact center premises. Incoming calls in some circumstances may also be routed through a gateway 103 into the well-known Internet network 106 as packet-switched calls. The interconnections in the Internet are represented by backbone 121. In this circumstance such a call may be further processed as a packet-switched IP call. Equipment providing SCP services may also connect to the Internet and may allow SCP functionality to be integrated with Internet-connected servers and intelligence at contact centers.

A call from a land-line telephone 104 connecting to switch 102 may be routed to the contact center 115 via trunk lines as shown to either a land-line switch 116 in the contact center 115 or to a Traffic Processor 117. The contact center 115 may operate with just one of the land-line switch or the traffic processor, but in some circumstances may employ both incoming paths. Traffic processor 117 may provide Session Border Control (SBC) functionality, may operate as a Media Gateway, or as a Softswitch.

Persons interacting through IP-enabled devices 108 (1-n) may interact through the Internet network via backbone 121, enabled by a variety of service providers 105 which operate to provide Internet service for such devices. Devices 102(1) and 102(2) may be IP-enabled telephones, operating under a protocol such as Session Initiation protocol (SIP). Appliance 108(3) is illustrated as a lap-top computer, which may be enabled by software for voice communication over packet networks such as the Internet, and may also interact in many other ways, depending on installed and operable software, such as Skype™. Similarly appliance 108(n) illustrated as a desktop computer, may interact over the Internet in much the same manner as laptop appliance 108(3).

Many IP-enabled devices provide capability for users to interact both in voice interactions and text interactions, such as email and text messaging services and protocols. Internet 106 may comprise a great variety of Internet-connected servers 107 and IP-enabled devices with Internet access may connect to individual ones of such servers to access services provided. Servers 107 in the Internet may comprise email servers, text messaging servers, social networking servers, Voice over IP servers (VoIP), and many more, many of which users may leverage in interaction with a contact center such as contact center 115.

Another arrangement by which users and agents may interact with contact centers is through mobile devices, illustrated in FIG. 1 by devices 110, 11 and 112. Such devices may include, but are not limited to laptop computers, iPad devices and smart telephones. Such devices are not limited by a land-line connection or by a hard-wired Internet connection as shown for telephones 104 or IP-enabled devices 108, and may be used by customers and agents from changing geographic locations and while in motion. Devices 110, 111 and 112 are illustrated in FIG. 1 as connecting through a wireless network 109, which may occur through individual ones of cell towers 113 associated with base stations having gateways such as gateway 114 illustrated, the gateways connected to Internet backbone 121.

In some circumstances mobile devices such as devices 110, 111 and 112 may connect to supplemental equipment operable in a moving vehicle. For example, cellular smartphones may be enabled for near-field communication such as Bluetooth™, and may be paired with equipment in an automobile, which may in turn connect to the Internet network through satellite equipment and services, such as On-Star™. Wireless communication may be provided as well in aircraft, which may provide an on-board base station, which may connect wirelessly to the Internet through either a series of ground stations over which an aircraft may pass in flight, or through one or more satellites.

Regardless of the variety of ways that Internet access may be attained by mobile devices, users of these devices may leverage Internet-connected servers for a great variety of services, or may connect through the Internet more directly to a contact center such as contact center 115, where users may interact as customers or as agents of the contact center.

Contact center 115, as described above, may represent one of a plurality of federated contact centers, a single center hosted by a single enterprise, a single contact center operating on behalf of a plurality of host enterprises, or any one of a variety of other arrangements. Architecture of an individual contact center 115 may also vary considerably, and not all variations may be illustrated in a single diagram such as FIG. 1. The architecture and interconnectivity illustrated in FIG. 1 is exemplary.

Equipment in a contact center such as contact center 115 may be interconnected through a local area network (LAN) 125. Land-line calls may arrive at a land-line switch 116 over trunk lines as shown from land-line network 101. There are a wide variety of land-line switches such as switch 116, and not all have the same functionality. Functionality may be enhanced by use of computer-telephony integration (CTI), which may be provided by a CTI server 118, which may note arriving calls, and may interact with other service units connected to LAN 125 to route the calls to agents connected to LAN 125, or in some circumstances may route calls to individual ones of remote agents who may be using any of land-line telephones 104, IP-enabled devices 108 or mobile devices represented by devices 110, 111 or 112. Calls may be queued in any one of a variety of ways before connection to an agent, either locally-based or remote from the contact center, depending on circumstances.

Incoming land-line calls to switch 116 may also be connected to an IVR server 119, which may serve to ascertain purpose of the caller and other information useful in further routing of the call to final connection. A router and conversation manager server 120 may be leveraged for routing intelligence, of which there may be a great variety, and for association of the instant call with previous calls or future calls that might be made.

Land-line calls thusly treated may be connected to agents at agent stations 127(1) or 127(2), each of which is shown as comprising a land-line telephone connected to switch 116 by destination number (DN) lines. Such calls may also be connected to remote agents using land-line telephones back through the land-line network. Such remote agents may also have computing appliances connected to the call center 115 for interaction with agent services such as scripting through an agent desktop application, also used by agents at agent stations 127.

Incoming calls from land-line network 101 may alternatively be connected in the contact center 115 through the Traffic Processor 117, described briefly above, to LAN 125. In some circumstances the Traffic Processor 117 may convert incoming calls to SIP protocol, and the such calls may be further managed by SIP Server 122.

Incoming calls from IP-enabled devices 108 or from mobile devices 110, 111 or 112, and a wide variety of text-based electronic communications may come to contact center 115 through the Internet, arriving in the Contact Center at an eServices Connector 130. eServices Connector 130 may provide protective functions, such as a firewall may provide in other architecture, and may serve to direct incoming transactions to appropriate service servers. For example, SIP calls may be directed to SIP Server 122, and text-based transactions may be directed to an Interaction Server 131, which may manage email, chat sessions, Short Message Serice (SMS) transactions, co-browsing sessions, and more. Interaction Server 131 may leverage services of other servers in the contact center, and available remotely as well.

Agent station 127(3) is illustrated as having a connected headset from a computing device, which may execute telephony software to interact with packet switched calls. Agent station 127(n) is illustrated as having an IP-enable telephone connected to LAN 125, through which an agent at that station may connect to packet-switched calls. Every agent station may have a computerized appliance executing software to enable the using agent to transact by voice, email, chat, instant messaging, and any other known communication process.

A statistics server 124 is illustrated in contact center 115, connected to LAN 125, and may provide a variety of services to agents operating in the contact center, and in some circumstances to customers of the contact center. Statistics may be used in contact center management to vary functionality in routing intelligence, load management, and in many other ways. A dB 126 may be provided to archive data and to provide temporary storage for many of the activities in contact center 115. An outbound server 123 is illustrated and may be used to manage outbound campaigns in the contact center, wherein calls may be made to destinations from a campaign list, and answered calls may be connected directly or be queued to be connected to agents involved in the outbound campaigns.

As described above, contact center 115, and the architecture and connectivity of the networks through which transaction is accomplished between customers and agents is exemplary, and there are a variety of ways that similar functionality might be attained with somewhat different architecture. The architecture illustrated is exemplary.

Typically, outbound may be just one function of the contact center, and there may be more than one outbound campaign in operation simultaneously. Further, many agents in the contact center may be dedicated to handling inbound traffic initiated from callers for a number of purposes. Typically a contact center may be dedicated to one commercial enterprise, such as a banking institution or an airline, for example. Taking the single example of a contact center operating on behalf of an airline, a portion of agents logged in at any one time may be assigned to receiving calls from customers seeking flight reservations, information on flight status and the like, and these agents may be partitioned to certain specialties, at least in part depending on training and known skills. Another portion of the agents may be dedicated to an outbound campaign, wherein calls answered from the outbound calls are routed to be connected to an available agent (established).

Depending on parameters that are set for an outbound campaign, such as dialing rate, and the number of agents dedicated to the campaign, when an outbound call is answered there may be no available agent to take the call. In this case, the answered call has to be queued for a next available agent, and the probability of losing that call increases dramatically. People called in outbound are not known to stay in queue for any long period of time waiting for an agent for a purpose that is at that point unknown to them. It is therefore a desirable goal in outbound to keep all the dedicated agents as busy as practical while always having one agent available to take the next answered call.

A purpose of a commercial contact center is to conduct business for the enterprise hosting the contact center, and the purpose of the business is to generate revenue for the host enterprise. There are, of course, many other kinds of enterprises, political, educational and the like, that have use for contact centers, and for outbound campaigns, but in one exemplary implementations of the present invention, it is commercial activity that is a main focus.

Not every established call in an outbound campaign brings positive revenue to an enterprise, but it is through established calls (answered from outbound and successfully connected to an agent) that sales and other benefits are accrued, so the net benefit to the enterprise from established calls over a period of time can be averaged over the number of calls to determine a monetary benefit per established call. One may presume that over a period of time a commercial enterprise might accrue statistics relating outbound campaigns to changes in revenue production, and that such statistics may over a period of time produce a relatively reliable indication of the per-call contribution to revenue of conducting outbound campaigns.

For abandoned calls there is no monetary benefit, but more usually a negative financial effect in the form of the telecom costs, missed sales opportunities, frustrated customers, and the like. Over a period of time an enterprise may similarly establish a reliable figure for the lost revenue associated with each abandoned call.

Because cost of agents as a resource is arguably the highest cost of managing a contact center, Agent Busy Factor is seen as an important characteristic. It is also true, however, that a very good Agent Busy Factor leads to an increase in abandoned calls. If there is a reduction in the probability of an agent being available to take a call when a person answers, there is a higher probability that more persons answering will hang up rather than wait for an agent to become available.

Since Agent Busy Factor and Overdial Rate are not intimately connected, it is typically a matter of trial to develop good operating parameters for an outbound campaign. But agent resources are a variable that can fluctuate considerably during an outbound campaign, and periodic readjustment of parameters is often desired.

According to exemplary embodiments, parameters for outbound may be set according to determination of Gain and Loss factors related to established and abandoned calls and the rate that calls are established or abandoned. In this regard, each successfully handled outbound call and each abandoned call both have distinct measurable fiscal value (positive or negative) to the contact center. Provided each contact center naturally aims to maximize value generation, it is desirable to develop a method of calculating the optimal dialing pace based on maximization of the value factor of the outbound campaign. The value added over a period of time for the outbound campaign may be determined, according to one example, as the difference between gain brought by established calls to loss caused by abandoned calls. Such approach helps simplify contact center administrator's task of picking proper optimization target values for a campaign. The contact center administrator simply has to define the difference of gain value brought by successful outbound call to a loss value caused by an abandoned call. If each established call brings a gain of “G” and each abandoned call causes a loss of “L”, then the total value factor TotalValueFactor (i.e. the total gain minus the total loss) over a period of time in the contact center is given by:

TotalValueFactor=G*Nest−L*Nab

where

Nest is the total number of the established calls (answered by agents);

Nab is the total number of the abandoned calls.

According to an exemplary embodiment, a dialing pace for the campaign in the calling center is calculated based on maximization of the total value factor brought by such campaign.

Implementation 1

According to one exemplary embodiment, an optimal dialing pace is dynamically calculated, which maximizes the total value factor for the current number of available agents, using a continuous traffic model with known dependencies of expected Agent Busy Factor and Overdial Rate on the dialing pace and the number of agents.

For continuous traffic models, the average value factor AR per average service time may be calculated as follows:

AR(DP,N)=G*N*ABF(DP,N)−L*DP*ODR(DP,N)

where

DP is the dialing pace in Erlang units (calls per average service time);

N is the number of agents;

ABF(DP, N) is Agent Busy Factor as function of DP and N;

ODR(DP, N) is Overdial Rate as function of DP and N;

G is the gain value per each established call (value greater than 0); and

L is the loss value per each abandoned call (value greater than 0).

The average, and hence total, value factor has an absolute maximum for an optimal dialing pace, which depends on the number of agents and the gain-to-loss specific ratio (G/L). If dependencies of expected Agent Busy Factor and Overdial Rate on the dialing pace and the number of agents are known (for instance, by Erlang-B or Erlang-A formulas), the optimal dialing pace is found by an iterative procedure either directly for the average value ratio (search of maximum) or for the first derivative of the average value ratio with respect to a dialing pace (search of zero first derivative).

Erlang dependencies for different situations are well-known to the skilled person, and ABF and ODR may be relatively easily determined given any one of many references, one of which is “Mathematical Foundations of Workforce Management”, Part I, Basic Formulae, Technical Report, Version 1.3, Apr. 9, 2004, published by Genesys Telecommunication Laboratories, Inc. of Daly City, Calif., the content of which is incorporated herein by reference.

So given the formula above, if G, L, and N are known, and ABF and ODR may be determined as functions of the known values of DP and N, one may assume a value for DP, and calculate AR.

Here is a working example:

We assume that an outbound campaign consists of 50 agents. The traffic model is Erlang-B, which is known to the skilled person. Erlang-B means that outbound calls typically spend 0 time in queue—each call is either handled immediately after hitting queue or get immediately abandoned. It has been determined over time for this enterprise under the same or similar conditions that the ratio of gain/loss is 2, which means that established outbound call is twice more valuable than the abandoned call. Each outbound call in average brings $2 and each abandoned call entails a loss of $1.

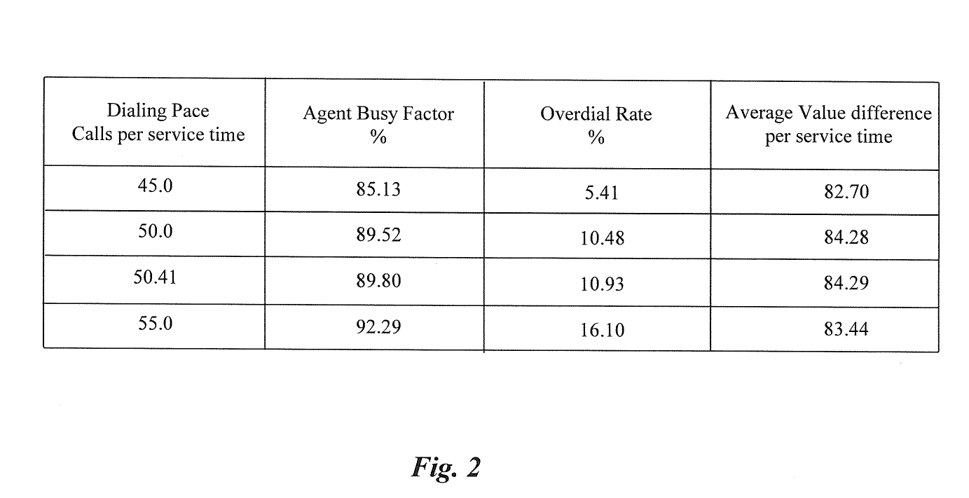

FIG. 2 is a table having four rows. A first step is to assume a DP in calls per service time, which has been assumed in the first row as 45 calls per service time. N=50, G=2 and L=1. Erlang-B formulas give ABF 85.13% and ODR 5.41%. The equation may now be solved for AR yielding a value of 82.7.

This is an iterative process, so one must vary the DP to see if the value factor increases or decreases. In this example it was decided to increase the DP to 50 and recalculate. The second row of the table shows that under the new assumption the AR increased to 84.28. Now the DP is again increased by the same factor of 5 to 55, and the AR decreases to 83.44 (see row 4). The decrease shows to the mathematically skilled person that the value for AR has passed through a maximum, and the absolute maximum is between DP at 50 and DP at 55. The process than focuses on increasing and decreasing DP by smaller amounts than 5, and reversing direction as max is passed, until the iterative procedure arrives at the Max for DP, which is shown in the third row as 84.29.

The skilled person will realize that this iterative procedure may be accomplished with powerful computation capability quite rapidly, and the system would set the DP at 50.41 until a variable changes, such as the number of agents.

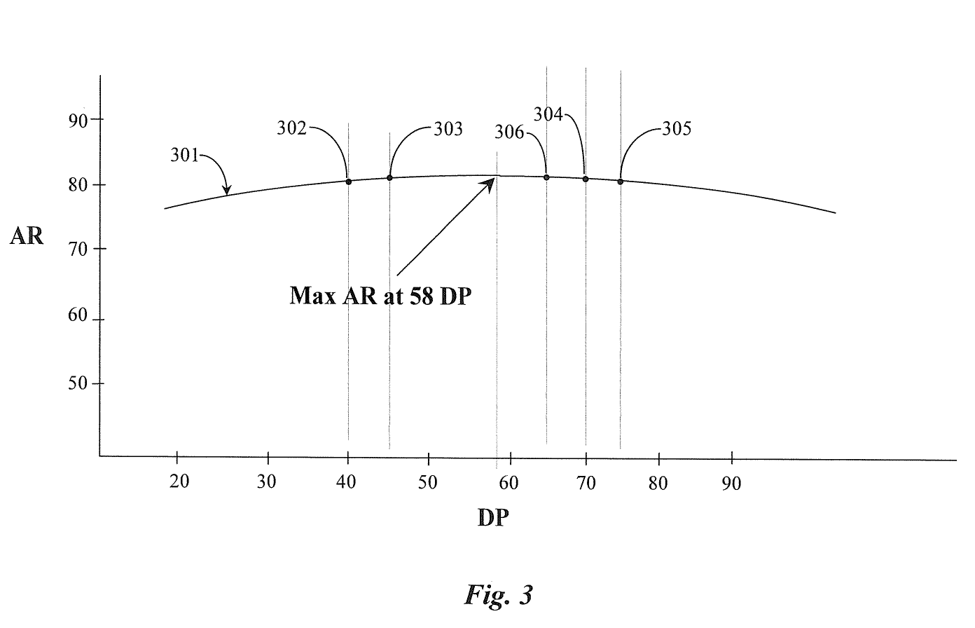

FIG. 3 is a generalized curve 301 illustrating how AR might vary in an Erlang-B situation depending on DP, illustrating a max for AR at about 58 calls per service time. This curve is exemplary only, and is used here to illustrate logical operation in an iterative process to determine DP to produce max AR. Since the max point for AR is initially unknown, one must arbitrarily assume a starting value for DP and calculate AR. Assume that the first DP assumed is 70, for which solving the equation for AR yields point 304 for AR. The next step is to increment DP and recalculate. The goal is to approach max AR. If a delta value for DP is taken as +5, DP becomes 75, and the next AR calculated will be at point 305, and clearly AR decreased, rather than increasing to approach a maximum value. So the system will know that adding to DP value lowered AR. There are two options. The system might subtract 2*delta, and recalculate, which would yield point 306, for which AR has certainly increased over the first AR calculated at point 304, and may be assumed to be the right direction to approach a maximum value for AR.

So, given the first value for DP, subtracting a delta value in the iterative process is one useful approach, and the system could continue subtracting delta from and recalculating until it is seen that AR decreases again, at which point the max for AR will be known to lie between the last two values for DP.

Assume now that DP at 40 is the first assumption, for which point 302 indicates calculated AR, and delta is still assumed at +5. The second calculation will render an increase for AR at point 303, meaning that adding delta is moving toward max AR. The system may continue to add delta and recalculate to approach and pass max AR. Then either extrapolation or finer calculation may be used as previously described to find max AR, and the DP value to produce the max return.

In some circumstances, particularly if changes in AR are seen to be small as the max value is approached, it will be sufficient to extrapolate between the last two values of DP for a good value for control. In a situation where the value of AR varies considerably between subsequent calculations, the system might optionally assume a smaller value of delta for DP, and approach max AR again by the described calculation. Theoretically this could be done repeatedly to determine a quite precise value for DP to produce maximum value for the contact center. Typically, however, such fine calculation will not be needed.

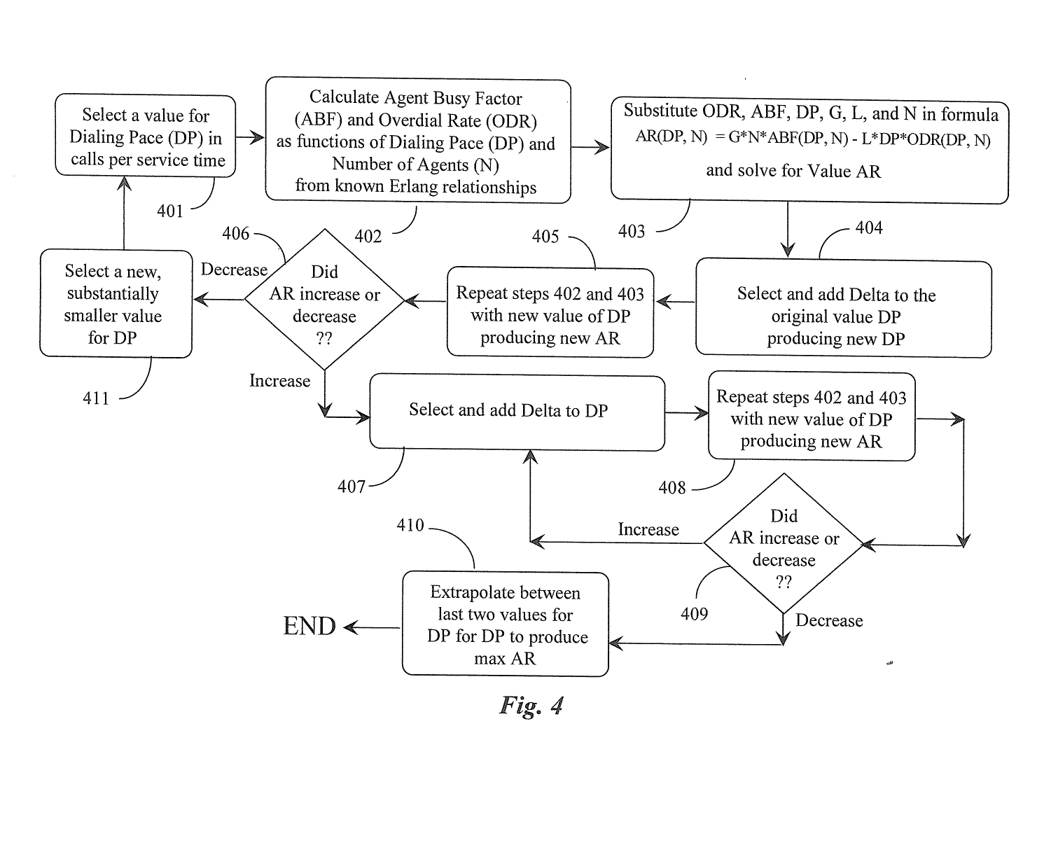

FIG. 4 is a flow diagram illustrating an exemplary process for accomplishing an iterative procedure in an Erlang-B situation to determine the DP that will produce the max return AR for the contact center. At act 401 a first value for dialing pace DP is assumed. At act 402 the system determines Agent Busy Factor (ABF) and Overdial Rate (ODR) from known Erlang relationships, with DP and N (number of agents) known. Next, at act 403 the now-known values are substituted into the equation above for AR, and first value for AR is calculated.

Returning for a moment to FIG. 3, it is likely not known at this point whether the first AR point lies on the left of max point of the curve relating DP to AR. Now at act 404 a delta value is assumed for DP and added to the first DP. At act 405 the determination and calculations of acts 402 and 403 are repeated. At act 406 it is determined whether the value for AR increased or decreased with added delta. If the value of AR decreased a new, substantially smaller value for DP is selected at act 411, which is substituted for DP at act 401, and the process is repeated until AR is seen to increase at act 406, at which point control goes to act 407, because it is known that the procedure is approaching the max AR by adding delta. Therefore at act 407 delta is again added to DP and recalculation is done at act 408. If AR increased again at act 409, delta is added again, and the loop 407, 408, 409 is repeated until AR is seen to decrease at act 409.

When AR decreases at act 409 the max point for AR has been passed, and a value for DP to produce maximum AR may be determined quite accurately by extrapolation at act 410 between the last two values for DP, which lie on opposite sides of the max point for AR. Alternatively (acts not shown) the value for DP that last produced an increase in AR may be assumed, and delta may be significantly reduced, such as by a factor of five or more, and the system can approach max for DP in smaller increments, raising the accuracy of the final determination.

The skilled artisan will recognize that this iterative procedure may be applied in a number of ways essentially equivalent to the example described. At any time the number of agents, the gain value for established calls or the loss value for abandoned calls changes, the iterative process is repeated to re-establish DP for max value returned to the contact center.

Implementation 2

According to one aspect of the invention, a method is provided to dynamically calculate the optimal number of outbound calls which should be dialed to maximize the total value ratio for a current number of ready agents and an expected percentage of answered calls.

In one example:

Two agents are ready to connect to answered outbound calls.

The expected percentage of answered calls to calls dialed: p=0.7 (70%)

The gain per established call: G=2

The loss per abandoned call: L=1

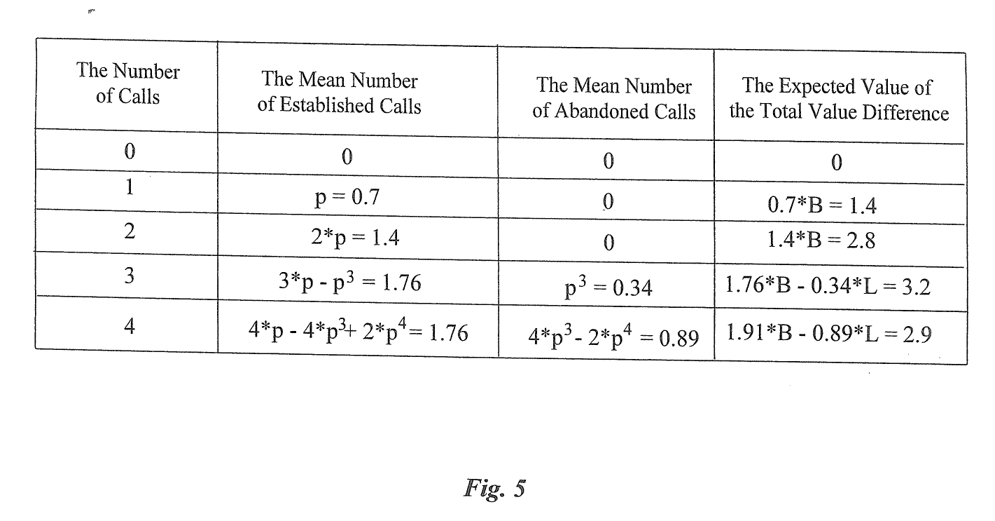

FIG. 5 illustrates a process in this implementation:

The iterative procedure simply starts with zero calls (first row) for which the mean number of established calls (connected to an agent) is zero, and the mean number of abandoned calls is also zero. So the total value difference is also zero.

Now the system assumes 1 call (second row), for which the mean number of established calls will be 0.7*1, or 0.7 (less than 1 call), and the mean number of abandoned calls is still zero. The expected value is 0.7*G, or 1.4.

The third row shows calculations for two calls with the formulas and calculated values for 2 calls. The value difference for three calls is 2.8.

The fourth row shows the calculations for 3 calls, and the value is established as 3.2.

The fifth row shows 4 calls, the mean number of established as 1.76, the mean number of abandoned as 0.89, and value 2.9. Clearly at some point between three calls and four calls the value maxed, then declined. In this circumstance three alls may be taken to maximize value.

This is a rather simplistic example, and the current number of ready agents may be greater than 2, and the expected answering percentage may change, but rapidly recalculating and adjusting the dialing pace can keep the value generation at or near a maximum.

One advantage accruing from this invention is that methods in implementations of the invention simplify the task of selection of optimization parameters for outbound campaigns run in a contact center. Further, the task of proper parameters selection is moved from a mathematical domain to a monetary gain/loss domain, which is more distinct and typically more clear and natural for campaign administrators. Instead of solving the question “to what value should I set Agent Busy Factor if I want my agents be busy but I do not want high abandoned rate”, the administrator now may answer the question “what is the value brought by the established call? What is the loss caused by the abandoned call?” and the process in an implementation of the invention will automatically keep optimal pace based on these input parameters, while maximizing value to the contact center. In addition, this unique approach to the selection of the optimization parameters automatically adapts to modifications in the campaign workforce during an outdialing session. The call center administrator does not have to recalculate optimization parameters for each shift of agents, for the optimization method automatically adjusts to the size of agent pool changes, still keeping outbound dialing at an optimum pace.

The processes described with respect to FIGS. 4 and 5 may be implemented by one or more servers depicted in FIG. 1 (e.g. the outbound server 123) according to program instructions stored in memory and executed by one or more processors hosted by the one or more servers. Of course, a person of skill in the art should recognize that the processes may also be implemented all or in part via firmware (e.g. ASIC), hardware, or a combination of software, firmware, and hardware.

Several implementations have been suggested as examples in the descriptions above, and that alterations to the examples may well be made without departing seriously from the intent of the invention. There are, for example several ways that the iterative procedures may be planned and performed, reaching substantially the same value for a set of parameters. The scope of the invention is limited only by the claims that follow.

1. A method for managing outbound dialing for a contact center, the method comprising:
establishing a formula for average value factor for an outbound campaign having a known number of dedicated contact center agents, a known financial gain for an established call, and a known financial loss for an abandoned call, wherein the average value factor is a function of a dialing pace and the known values;
assuming a first value for dialing pace and calculating by a computing device having a processor, following the established formula, a first average value factor;
assuming a second value for dialing pace, repeating calculation of average value factor by the computing device, and noting direction of change in the calculated average value factor;
determining a maximum for the average value factor by successive choices for dialing pace chosen to increase the average value factor; and
implementing the outbound campaign based on the dialing pace that produces in calculation the maximum average value factor.

2. The method of claim 1 further comprising:
upon the number of dedicated agents changing, repeating the process for determining the maximum average value factor, and establishing a new dialing pace that results in the maximum average value factor for the new number of dedicated agents.

3. The method of claim 1 further comprising:
upon the known financial gain for an established call changing, repeating the process for determining the maximum average value factor, and establishing a new dialing pace that results in the maximum average value factor for the new value of financial gain.

4. The method of claim 1 further comprising:
upon the financial loss for an abandoned call changing, repeating the process for determining the maximum average value factor, and establishing a new dialing pace that results in the maximum average value factor for the new value for financial loss.

5. The method of claim 1 further comprising:
determining an agent busy factor as a function of dialing pace and number of agents as a part of the calculations using the established formula.

6. The method of claim 1 further comprising:
determining an overdial rate as a function of dialing pace and number of agents as a part of the calculations using the established formula.

7. The method of claim 1 further comprising:
determining, after calculating a first average value factor, whether increasing or decreasing the value for dialing pace causes the average value factor to increase or decrease, and adjusting the second and subsequent choices for dialing pace to cause the average value factor to increase until the maximum value is reached.

8. A method comprising:
establishing a formula for average value factor for an outbound campaign having a known number of dedicated agents, a known financial gain for an established call, and a known financial loss for an abandoned call, wherein the average value factor is a function of dialing pace and the known values;
assuming a first value for dialing pace and calculating by a computing device having a processor, following the established formula, a first average value factor; and
assuming a second value for dialing pace, repeating calculation of average value factor by the computing device, and noting direction of change in the calculated average value factor;
determining a maximum for the average value factor by successive choices for dialing pace chosen to increase the average value factor; and
using the dialing pace that produces in calculation the maximum average value factor to drive the outbound campaign.

9. An apparatus for managing outbound dialing for a contact center, comprising:
a processor; and
a memory, the memory storing instructions that when executed by the processor, cause the processor to:
establish a formula for average value factor for an outbound campaign having a known number of dedicated contact center agents, a known financial gain for an established call, and a known financial loss for an abandoned call, wherein the average value factor is a function of a dialing pace and the known values;
assume a first value for dialing pace and calculate following the established formula, a first average value factor;
assume a second value for dialing pace, repeat calculation of average value, and note direction of change in the calculated average value factor;
determine a maximum for the average value factor by successive choices for dialing pace chosen to increase the average value factor; and
implement the outbound campaign based on the dialing pace that produces in calculation the maximum average value factor.

10. The apparatus of claim 8, wherein the program instructions further cause the processor to:
upon the number of dedicated agents changing, repeat the process for determining the maximum average value factor, and establish a new dialing pace that results in the maximum average value factor for the new number of dedicated agents.

11. The apparatus of claim 8, wherein the program instructions further cause the processor to:
upon the known financial gain for an established call changing, repeat the process for determining the maximum average value factor, and establish a new dialing pace that results in the maximum average value factor for the new value of financial gain.

12. The apparatus, wherein the program instructions further cause the processor to:
upon the financial loss for an abandoned call changing, repeat the process for determining the maximum average value factor, and establish a new dialing pace that results in the maximum average value factor for the new value for financial loss.

13. The apparatus of claim 8, wherein the program instructions further cause the processor to:
determine an agent busy factor as a function of dialing pace and number of agents as a part of the calculations using the established formula.

14. The apparatus of claim 8, wherein the program instructions further cause the processor to:
determine an overdial rate as a function of dialing pace and number of agents as a part of the calculations using the established formula.

15. The apparatus of claim 8, wherein the program instructions further cause the processor to:
determine, after calculating a first average value factor, whether increasing or decreasing the value for dialing pace causes the average value factor to increase or decrease, and adjust the second and subsequent choices for dialing pace to cause the average value factor to increase until the maximum value is reached.
